(19) United States
(12) Patent Application Publication
(10) Pub. No.: US 2010/0099300 A1
(43) Pub. Date: Apr. 22, 2010

(54) Cable Connector With A U-Shaped Connecting Seat Having A Shielding Cover Over The Connecting Seat For Preventing Electromagnetic Leakage

(76) Inventor: Chi-Feng HSIEH, Taipei (TW)

Correspondence Address: Muncy, Geissler, Olds & Lowe, PLLC, P.O. BOX 1364, FAIRFAX, VA, 22038-1364, US

(21) Appl. No.: 12/254,179

(22) Filed: Oct. 20, 2008

(51) Int. Cl. H01R 9/03

(52) U.S. Cl. 439/607.41

(57) ABSTRACT

A cable connector preventing electromagnetic leakage includes a main body assembly having a tubular main body and a lying U-shaped connecting seat connected to a printed circuit board (PCB); a contact conductor having a horizontal core section mounted in the tubular main body and a vertical connecting section electrically connected to the PCB; an insulating element unit mounted in the tubular main body for insulating the contact conductor from the main body assembly and supporting the contact conductor; and a shielding cover fastened to the U-shaped connecting seat for completely shielding upper and rear openings of the lying U-shaped connecting seat to prevent electromagnetic leakage.

### FIELD OF THE INVENTION

The present invention relates to a cable connector, and more particularly to a cable connector preventing electromagnetic leakage.

### BACKGROUND OF THE INVENTION

FIGS. 1 and 2 are sectioned side view and exploded perspective view, respectively, showing a conventional cable connector 10 for soldering to a printed circuit board (PCB). The cable connector 10 includes a tubular main body 11 internally defining a bore 12, and a first insulating element 13 and a second insulating element 14 mounted in the bore 12 respectively at a front and a rear end thereof. The tubular main body 11 is provided at a rear end around the bore 12 with a plurality of equally spaced and radially protruded keys 15.

The cable connector 10 further includes a U-shaped connecting seat 16 having a transverse portion 17 and two side portions. The transverse portion 17 is formed with a through hole 18 having a plurality of engaging notches 19 equally spaced therearound to correspond to the keys 15 on the tubular main body 11. The keys 15 on the tubular main body 11 are engaged with the engaging notches 19 on the connecting seat 16 before the tubular main body 11 is riveted to the connecting seat 16.

The cable connector 10 further includes a right-angled contact conductor 111 having a horizontal core section 112 and a vertical connecting section 113. The core section 112 is extended through and tightly received in two holes separately axially formed on the first and the second insulating element 13, 14. The connecting section 113 is connected to a conducting circuit on the PCB to electrically connect the contact conductor 111 to the PCB.

In the above arrangements, the U-shaped connecting seat 16 is not provided with any shielding structure and the contact conductor 111 has some part not shielded by the U-shaped connecting seat 16 to thereby result in electromagnetic leakage, which not only causes electromagnetic interference (EMI) with communication signals, but also endangers human body.

### SUMMARY OF THE INVENTION

A primary object of the present invention is to provide a cable connector that can effectively prevent electromagnetic leakage.

To achieve the above and other objects, the cable connector preventing electromagnetic leakage according to the present invention includes a main body assembly having a tubular main body and a lying U-shaped connecting seat connected to a printed circuit board (PCB); a contact conductor having a horizontal core section mounted in the tubular main body and a vertical connecting section electrically connected to the PCB; an insulating element unit mounted in the tubular main body for insulating the contact conductor from the main body assembly and supporting the contact conductor; and a shielding cover fastened to the U-shaped connecting seat for completely shielding all open sides of the U-shaped connecting seat to prevent electromagnetic leakage.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a sectioned side view of a conventional cable connector;

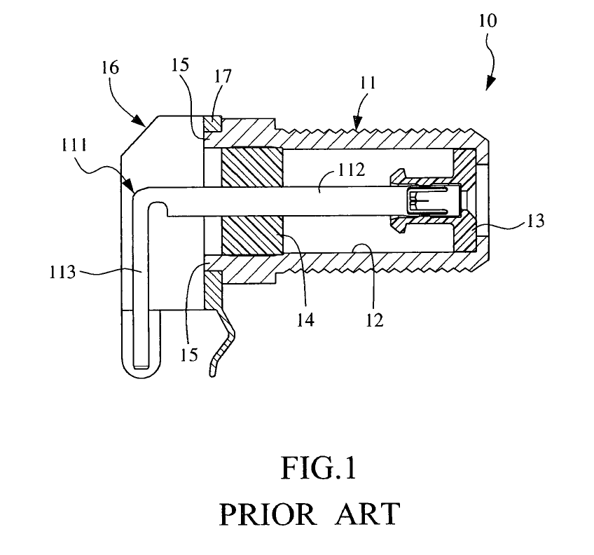

FIG. 2 is an exploded perspective view of the conventional cable connector shown in FIG. 1;

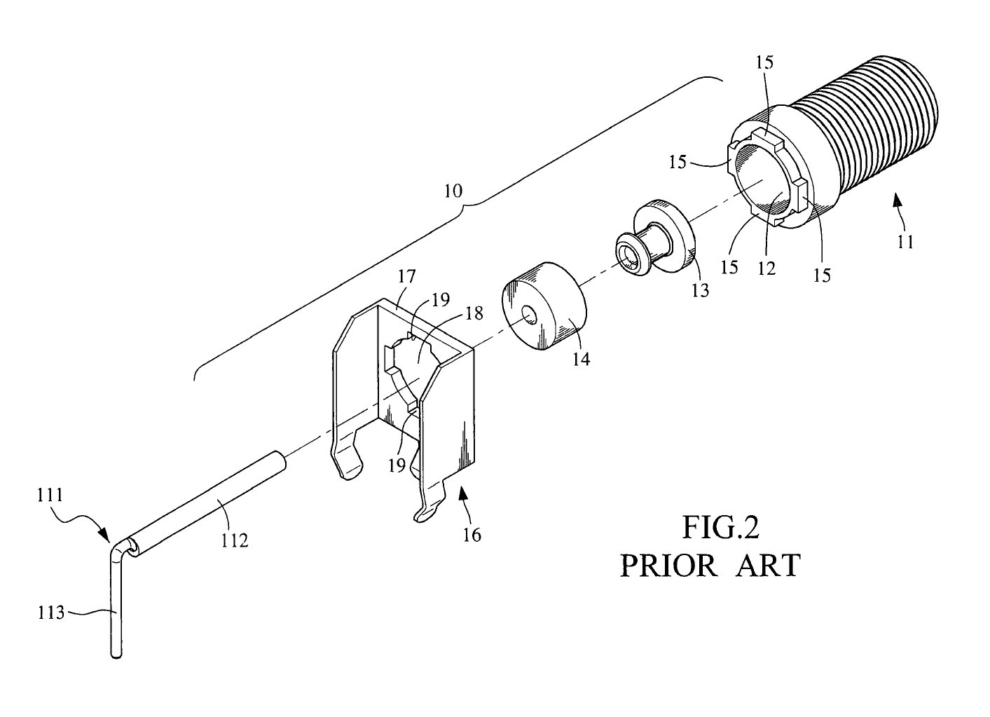

FIG. 3 is an assembled perspective view of a cable connector preventing electromagnetic leakage according to a preferred embodiment of the present invention;

FIG. 4 is a partially exploded view of the cable connector of FIG. 3;

FIG. 5 is a sectional view taken along line 5-5 of FIG. 3; and

FIG. 6 is a perspective view showing the cable connector of the present invention before being connected to a printed circuit board.

### DETAILED DESCRIPTION OF THE PREFERRED EMBODIMENTS

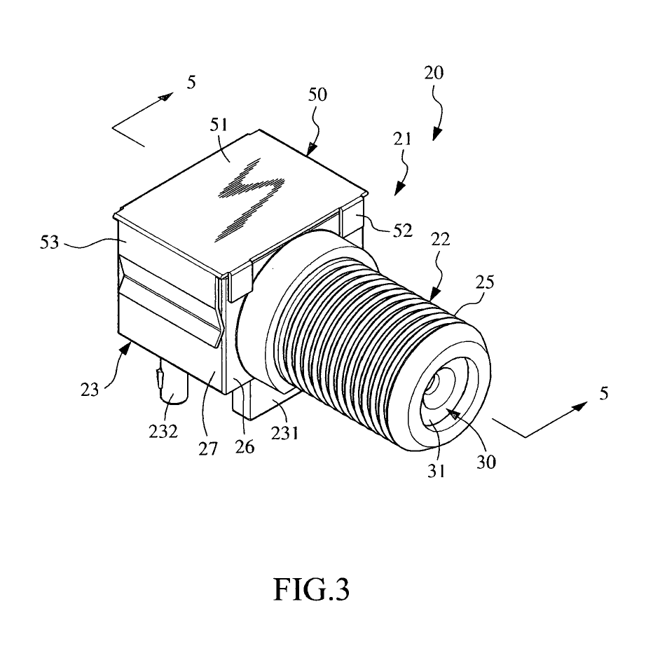

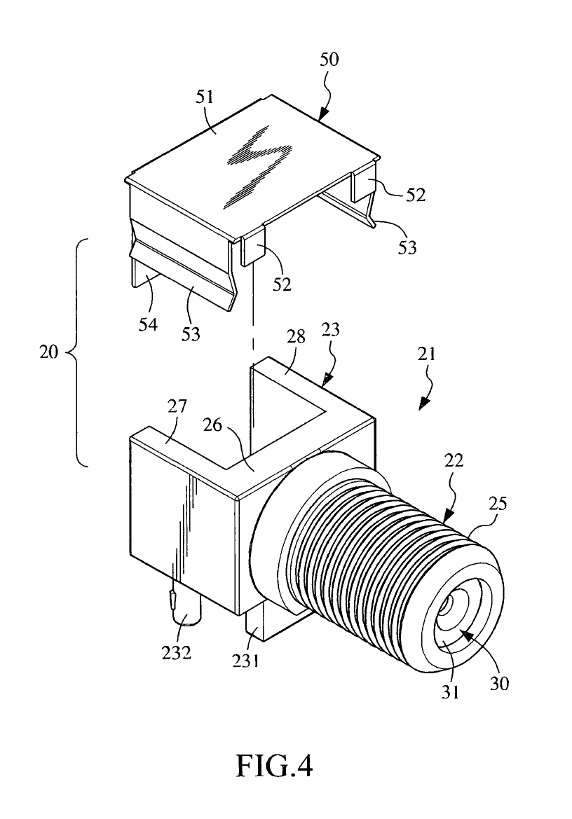

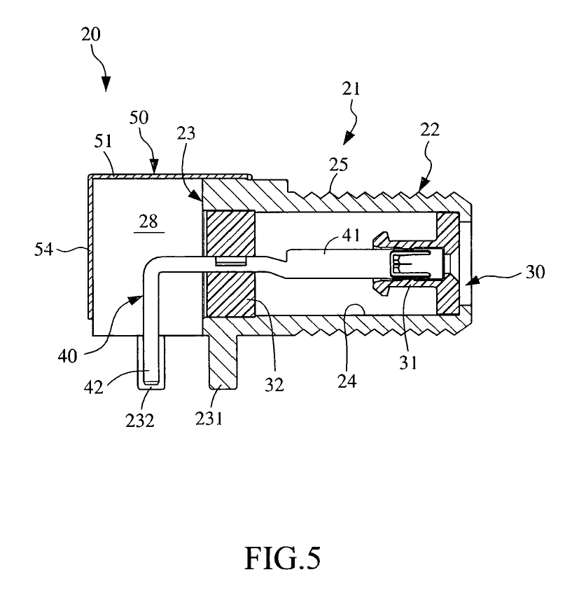

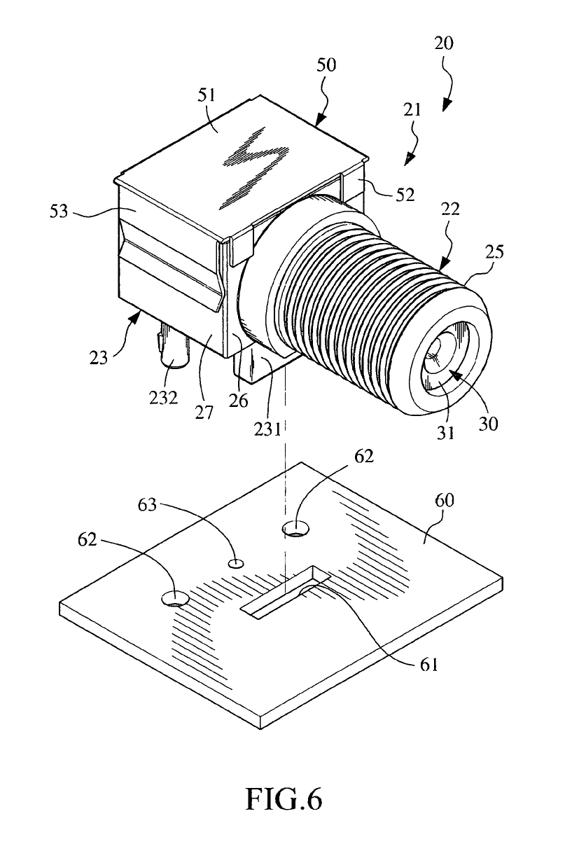

Please refer to FIGS. 3 to 5. In a cable connector preventing electromagnetic leakage according to a preferred embodiment of the present invention, which is generally denoted by reference numeral 20, there are included a main body assembly 21, an insulating element unit 30, a contact conductor 40, and a shielding cover 50. The cable connector 20 can be fixedly connected to a printed circuit board (PCB) 60 by soldering, as shown in FIG. 6.

The main body assembly 21 is made of a metal material, and includes a tubular main body 22 and a lying U-shaped connecting seat 23. The U-shaped connecting seat 23 is integrally formed on the tubular main body 22 for connecting to the PCB 60. The tubular main body 22 internally defines a bore 24 for receiving the insulating element unit 30 therein. The tubular main body 22 is externally formed with screw threads 25 for mechanically and electrically connecting to an internally threaded interface connector (not shown). The U-shaped connecting seat 23 includes a transverse portion 26 connected to a rear end of the tubular main body 22, and a left side portion 27 and a right side portion 28 respectively rearward extended from two lateral ends of the transverse portion 26.

The connecting seat 23 further includes a locating leg 231 downward protruded from the transverse portion 26, and two engaging legs 232 respectively downward protruded from the left and the right side portion 27, 28. The locating leg 231 can be received in a first hole 61 correspondingly formed on the PCB 60, and the two engaging legs 232 can be fitted in two second holes 62 correspondingly formed on the PCB 60, so that the locating leg 231 and the engaging legs 232 are connected to a conducting circuit on the PCB to ground the main body assembly 21, as shown in FIG. 6.

The insulating element unit 30 includes a first insulating element 31 mounted in the bore 24 at a front end thereof, and a second insulating element 32 mounted in the bore 24 at a rear end thereof. With the insulating element unit 30, the contact conductor 40 is insulated from the main body assembly 21.

The contact conductor 40 is in a right-angled shape, and includes a horizontal core section 41 and a vertical connecting section 42. The core section 41 is transversely extended through and received in two holes respectively formed on the first insulating element 31 and the second insulating element 32, and the connecting section 42 is vertically extended through a third hole 63 correspondingly formed on the PCB 60 to connect to the conducting circuit on the PCB 60, so that the contact conductor 40 is electrically connected to the PCB 60, as shown in FIG. 6.

The shielding cover 50 is fastened to the lying U-shaped connecting seat 23. The shielding cover 50 is formed by stamping to include a substantially rectangular top portion 51 for shielding an upper opening of the lying U-shaped connecting seat 23, and four downward bent side portions extended from four edges of the top portion 51. The four side portions include a front portion in the form of a plurality of lugs 52 bearing on an outer face of the transverse portion 26 of the connecting seat 23, two resilient lateral portions 53 separately elastically and tightly pressing against the left and the right side portion 27, 28 of the connecting seat 23, and a rear shielding portion 54 for blocking a rear opening of the lying U-shaped connecting seat 23.

When the shielding cover 50 is fastened to the lying U-shaped connecting seat 23, the upper and rear openings of the lying U-shaped connecting seat 23 are completely closed by the shielding cover 50. Accordingly, the problem of electromagnetic leakage existing in the conventional cable connector can be obviated.

The present invention has been described with a preferred embodiment thereof and it is understood that many changes and modifications in the described embodiment can be carried out without departing from the scope and the spirit of the invention that is intended to be limited only by the appended claims.

1. A cable connector for preventing electromagnetic leakage for connecting to a printed circuit board (PCB) comprising:
a main body assembly having a tubular main body and a lying U-shaped connecting seat connected at a lower side to the PCB;
a contact conductor having a horizontal core section and a vertical connecting section, the core section being fixed in the tubular main body, and the connecting section being electrically connected to the PCB;
an insulating element unit mounted in the tubular main body for insulating the contact conductor from the main body assembly and supporting the contact conductor; and
a shielding cover, having a top portion for shielding an upper opening of the lying U-shaped connecting seat and a resilient lateral portion downwardly bent and extended from two lateral edges of the top portion, the resilient lateral portion being fastened to the U-shaped connecting seat, the shielding cover completely shielding upper and rear openings of the lying U-shaped connecting seat to prevent electromagnetic leakage.

2. The cable connector preventing electromagnetic leakage as claimed in claim 1, wherein the tubular main body and the U-shaped connecting seat are integrally formed.

3. The cable connector preventing electromagnetic leakage as claimed in claim 1, wherein the shielding cover has a rear shielding portion downwardly bent and extended from a rear edge of the top portion for blocking the rear opening of the lying U-shaped connecting seat.

4. The cable connector preventing electromagnetic leakage as claimed in claim 3, wherein the shielding cover further includes a front portion being in the form of a plurality of lugs bearing on an outer face of a transverse portion of the lying U-shaped connecting seat, and the two resilient lateral portions separately elastically and tightly pressing against a left and a right side portion of the lying U-shaped connecting seat.

5. The cable connector preventing electromagnetic leakage as claimed in claim 1, wherein the shielding cover extends only over the U-shaped connecting seat wit a majority of the main body assembly being exposed outside the shielding cover.

6. The cable connector preventing electromagnetic leakage as claimed in claim 5, wherein the tubular main body has a threaded outer surface mechanically connect to an internally threaded interface connector.
